(19) United States
(12) Patent Application Publication
(10) Pub. No.: US 2006/0251107 A1
(43) Pub. Date: Nov. 9, 2006

(54) Method and system for collision avoidance in wireless communications

(76) Inventors: Bruce E. Geren, Chandler, AZ (US); Bobby D. Anderson, Gilbert, AZ (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/111,417

(22) Filed: Apr. 21, 2005

(51) Int. Cl. H04J 3/02

(52) U.S. Cl. 370/462

(57) ABSTRACT

The invention concerns a method (300) and mobile unit (110) for reducing transmission collisions. The method can include—in a systemless call environment—receiving (314) at a plurality of receiving mobile units (110B, 110C) a call from an original transmitting mobile unit (110A) and in the plurality of receiving mobile units, selectively randomly delaying (316) transmissions from the receiving units to reduce the probability that such transmissions will collide with one another. The selectively randomly delaying a transmission at the receiving units step can include performing (318) a pre-transmission scan when a transmission element (112) of one of the receiving mobile units is activated or by assigning (330) a random delay to an idle mode (400) following a receive session in the receiving mobile units.

### BACKGROUND OF THE INVENTION

1. Field of the Invention

This invention relates in general to wireless communications and more particularly, to collision avoidance in wireless communications.

2. Description of the Related Art

Some mobile communications units employ a simplex or half-duplex mode of communication. Using this mode, a mobile communication unit can transmit and receive signals but cannot do both simultaneously. Some communications networks enable mobile communications units that operate in the half-duplex mode to communicate with one another in groups. In this arrangement, sometimes referred to as a group call, the mobile communications units can transmit signals to and receive signals from any of the other mobile communications units that are part of the group.

In the group setting, it is desirable that only one mobile unit transmit at any given time to avoid transmission collisions, which can disrupt communications. In a communications network that includes a central controller, such as a base station, the central controller typically provides a timing signal to keep the mobile units synchronized. This timing signal can help prevent transmission collisions, or doubletalk, between the mobile units in a group call.

Recently, methods have been developed to permit mobile units to communicate with one another without the use of a network. For example, Motorola, Inc. of Schaumburg, Ill. has developed mobile units that can alternately communicate with one another with or without the assistance of a dispatch communications network. The setting in which mobile units communicate with one another without the use of a network can be referred to as a systemless call environment. Group calls can also be performed in a systemless call environment.

In a systemless call environment, the mobile units are constantly scanning various frequencies for an indication of an upcoming transmission from another mobile unit in the environment. To limit battery drain during this type of operation, idle/scan periods of a predetermined length of time have been developed in which the idle scan period includes an idle stage and a scan stage. As an example, the idle/scan period may be roughly 80 milliseconds (msecs) long, with the idle stage being 64 msecs long and the scan stage being 16 msecs long. During the idle stage time of 64 msecs, portions of the mobile unit can enter a sleep mode to save battery life. The scanning process is performed during the relatively short scan stage. Presently, some mobile units will not begin a transmission until the current idle/scan period is completed, while other mobile units may initiate transmission right away.

In a group call in a systemless call environment, a mobile unit may transmit a message to two or more other mobile units. The receiving mobile units will synchronize with the transmitting mobile unit to enable the group call to take place. There is a possibility that the users of the receiving mobile units may press a transmit button within the same 80 msec idle/scan period. If so, both mobile units may hold off the initiated transmission until the idle/scan period is complete. Thus, even though a user of one mobile unit may have pressed his transmit button first, because it occurred in the same idle/scan period as when a user of a second mobile unit pressed his transmit button, both mobile units will begin transmission at the same time. This process will cause a transmission collision between the two mobile units. In addition, for those mobile units that begin transmission right away, a transmission collision may occur if the mobile units transmit within the same idle/scan period.

### SUMMARY OF THE INVENTION

The present invention concerns a method for reducing transmission collisions. The method can include the steps of—in a systemless call environment—receiving at a plurality of receiving mobile units a call from an original transmitting mobile unit and in the plurality of receiving mobile units, selectively randomly delaying transmissions from the receiving mobile units to reduce the probability that such transmissions will collide with one another.

In one arrangement, the step of selectively randomly delaying a transmission at the receiving mobile units can include performing a pre-transmission scan when a transmission element of one of the receiving mobile units is activated. If the pre-transmission scan determines that no other receiving mobile unit has begun to transmit, the method can further include the step of initiating transmission in the receiving mobile unit whose transmission element has been activated.

Conversely, if the pre-transmission scan determines that another receiving mobile unit has begun to transmit, the method can further include the step of preventing transmission in the receiving mobile unit whose transmission element has been activated. Also, if the transmission from the other receiving mobile unit is intended for the receiving mobile unit whose transmission has been prevented, the method can further include the step of processing the transmission from the other receiving mobile unit at the receiving mobile unit whose transmission has been prevented.

In another arrangement, selectively randomly delaying a transmission at the receiving mobile units can include the step of assigning a random delay to an idle mode following a receive session in the receiving mobile units. As an example, the step of assigning the random delay can include the step of assigning different seeds for pseudo-random number generators in the receiving mobile units to cause the random delay in the idle mode.

In another embodiment, during an idle mode, the method can further include the step of performing an idle/scan period at the receiving units to determine the presence of an incoming call. As an example, the idle/scan period can include an idle stage and a scan stage. The method can further include the step of completing an existing scan stage in lieu of performing a pre-transmission scan when a user of one of the receiving mobile units activates a transmission element. In yet another arrangement, the method can include the step of repeating the delaying of the transmission at the receiving mobile units such that a delay is performed over a plurality of scans.

The present invention also concerns a mobile unit for reducing transmission collisions. The mobile unit can include a transmitter, a receiver and a processor coupled to the transmitter and the receiver. The processor can be programmed to detect the receipt of a call from an original transmitting mobile unit in a systemless call environment and to selectively randomly delay a transmission from the mobile unit to reduce the possibility that such a transmission will collide with a transmission from another receiving unit. The mobile unit can also include suitable software and circuitry for performing the processes described above.

The present invention also concerns a machine readable storage having stored thereon a computer program having a plurality of code sections executable by a mobile unit. The program can cause the mobile unit to—in a systemless call environment—receive a call from an original transmitting mobile unit and in the plurality of receiving mobile communications units, to selectively randomly delay a transmission from the mobile unit to reduce the probability that such a transmission will collide with another transmission. The program can also cause the mobile unit to execute one or more of the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a systemless call environment in accordance with an embodiment of the inventive arrangements;

FIG. 2 illustrates an example of a mobile unit that can be used in the systemless call environment of FIG. 1 in accordance with an embodiment of the inventive arrangements;

FIG. 3 illustrates a method of reducing collisions in wireless communications in accordance with an embodiment of the inventive arrangements;

FIG. 4 illustrates an example of an idle mode in accordance with an embodiment of the inventive arrangements;

FIG. 5 illustrates an example of a frame sequence in accordance with an embodiment of the inventive arrangements;

FIG. 6 illustrates an example of a pre-transmission scan in accordance with an embodiment of the inventive arrangements; and

FIG. 7 illustrates two randomly-delayed idle modes for receiving mobile units in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and mobile unit for reducing transmission collisions. In one arrangement, the method can include the steps of—in a systemless call environment—receiving at a plurality of receiving mobile units a call from an original transmitting mobile unit and in the plurality of receiving mobile units, selectively randomly delaying transmissions from the receiving units to reduce the probability that such transmissions will collide with one another. The selectively randomly delaying a transmission at the receiving units step can include performing a pre-transmission scan when a transmission element of one of the receiving mobile units is activated. Alternatively, the selectively randomly delaying a transmission at the receiving units step can include assigning a random delay to an idle mode following a receive session in the receiving mobile units.

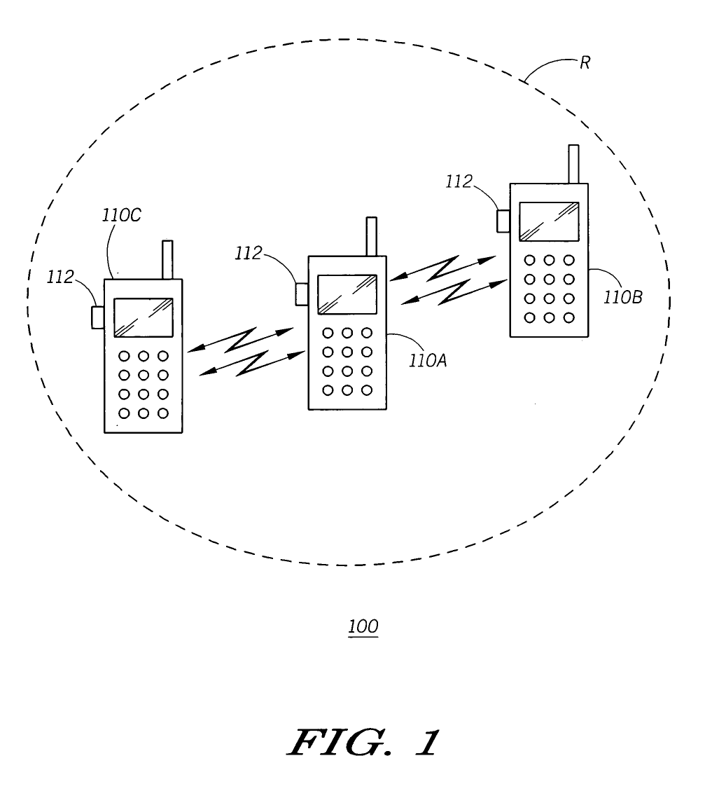

Referring to FIG. 1, a systemless call environment 100 is shown. As an example, the systemless call environment 100 can include any suitable number of mobile units 110, each of which can be further designated by a reference letter to enable the reader to distinguish between the mobile units 110. For purposes of the invention, a systemless call environment can be any setting in which any suitable number of mobile units can communicate with one another without the assistance of a communications network. For example, mobile unit 110A can readily communicate with mobile units 110B and 110C without a network facilitating the transmission of the signals, so long as the mobile units 110B and 110C remain within an operating range R of the mobile unit 110A.

In this example, the mobile unit 110A can send a transmission to mobile units 110B and 110C. Either or both the mobile units 110B and 110C can receive the transmission from the mobile unit 110A and can send a transmission back to the mobile unit 110A. As such, for clarity in explaining the operation of the invention, the mobile unit 110A will be referred to as a transmitting mobile unit, and the mobile units 110B and 110C will be referred to as receiving mobile units. Of course, the systemless call environment 100 can include any suitable number of mobile units 110, all capable of conducting wireless communications among each other. When three or more mobile units 110 are involved in the same call, the call can be referred to as a group call.

In one arrangement, the mobile units 110 can be cellular telephones that are capable of conducting half-duplex of full-duplex communications. As an example, the mobile units 110 can include transmission elements 112, which when activated, can cause the mobile units 110 to transmit half-duplex signals in the systemless call environment 100. As a more specific example, the transmission elements 112 can be push-to-talk (PUTT) buttons, which a user can press to cause the mobile units 110 to transmit. Of course, the invention is not so limited, as the term mobile unit can mean any portable device that is capable of transmitting and receiving wireless signals, whether from a network or another mobile unit. In addition, the transmission element 112 can be any other feature that can cause the mobile unit 110 to transmit signals.

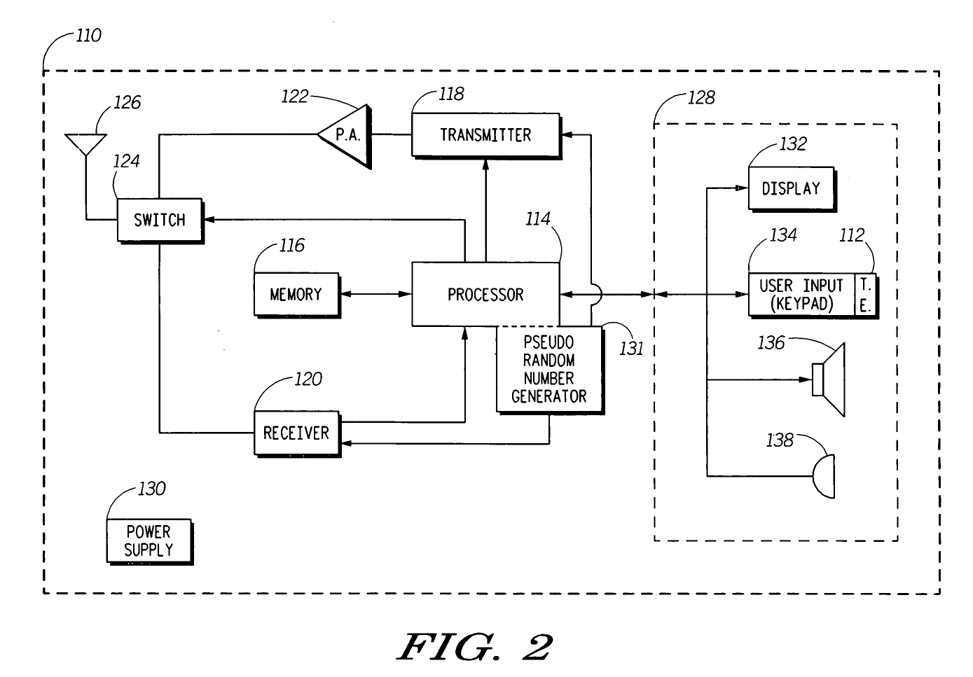

Referring to FIG. 2, an example of a mobile unit 110 is shown. Here, the mobile unit 110 can include a processor 114, a memory 116, a transmitter 118, a receiver 120, a power amplifier (PA) 122, a transmission switch 124, an antenna 126, a user interface section 128 and a power supply 130. The processor 114 can be communicatively coupled to the memory 116, the transmitter 118, the receiver 120, the transmission switch 124 and the user interface 128. The mobile unit 110 can also include a pseudo-random number generator 131, which can be part of the processor 114. The pseudo-random number generator 131, however, may also be part of some other component, or it may be a stand-alone device. In one arrangement, the user interface section 128 can include a display 132, a user input 134, a speaker 136 and a microphone 138.

The memory 116, as is known in the art, can store instructions and other forms of data for permitting the processor 114 to perform operations in accordance with the inventive arrangements. Also, the transmitter 118 can process signals from the processor 114 for transmission in accordance with well-known procedures. The PA 122 can amplify these signals, and if the processor 114 has set the transmission switch 124 to transmit, the signals can be transmitted from the antenna 126.

The antenna 126 can also transfer received signals to the receiver 120 through the transmission switch 124 if the transmission switch 124 is set to receive. The receiver 120 can process the incoming signals in accordance with well-known principles and can forward them to the processor 114. In one arrangement, the processor 114 can transfer the received signals to one or more of the components of the user interface section 128, such as the display 132 or the speaker 136.

The user interface section 128 can also forward signals to the processor 114 from one or more of its components, like the user input 134 or the microphone 138. As an example, the user input 134 can include a keypad and other buttons or controls that can be manipulated by a user. It is understood, however, that the user input 134 can be any component capable of receiving any user input and converting it to a form that can be received and processed by the processor 114. In one arrangement, the transmission element 112 (see FIG. 1) can be part of the user input 134. The power supply 130 can provide power to one or more of the components described above. As an example, the power supply can be one or more rechargeable batteries. The pseudo-random number generator 131 can assist in the synchronization (or desynchronization, as will be explained below) of the mobile unit 110 with other mobile units.

Although several elements of an example of a mobile unit 110 have been presented here, the mobile unit 110 may not contain all these components. In addition, the mobile unit 110 may include several components not shown here, such as a global positioning system (GPS) circuit. It must also be noted that the invention is in no way limited to this particular example, as any other suitable mobile unit can be used to practice the inventive arrangements.

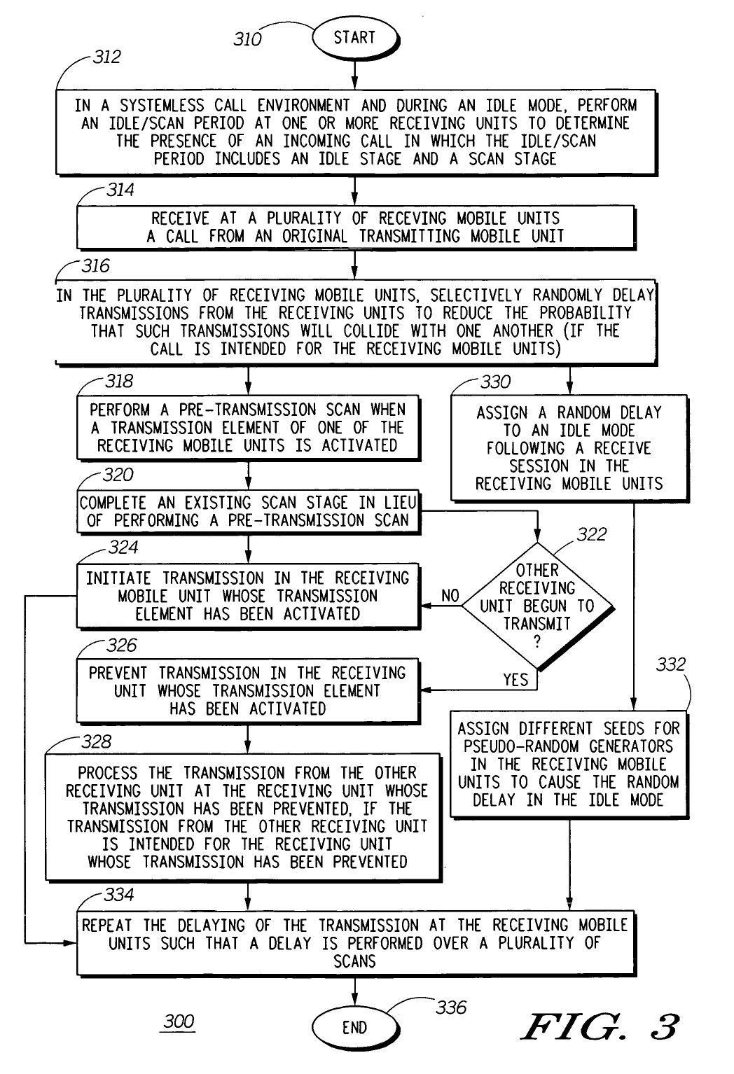

Referring to FIG. 3, a method 300 for reducing transmission collisions in wireless communications is shown. To describe the method 300, reference will be made to FIGS. 1 and 2 (and several other drawings, as will be described below), although it is understood that the method 200 can be implemented in any other suitable device or system using other suitable components. Moreover, the invention is not limited to the order in which the steps are listed in the method 300. In addition, the method 300 can contain a greater or a fewer number of steps than those shown in FIG. 3.

At step 310, the method 300 can begin. At step 312, in a systemless call environment and during an idle mode, an idle/scan period can be performed at one or more mobile units to determine the presence of an incoming call. The idle/scan period can include an idle stage and a scan stage.

Referring to FIG. 4, an example of an idle mode 400 having a plurality of idle/scan periods 412 is shown. In one arrangement, the idle/scan periods 412 can include an idle stage 414 and a scan stage 416. Referring now to FIGS. 2 and 4, during the idle stage 414, the processor 114 and the receiver 120 can enter a reduced mode of operation in which at least certain portions of these components are shut down. At the scan stage 416, the processor 114 and the receiver 120 can exit the reduced mode of operation, and the receiver 120 can perform a scan of one or more frequencies to determine whether a call is incoming. As an example but without limitation, the idle/scan period 412 can be approximately 80 msecs, the idle stage 414 can be around 64 msecs and the scan stage 416 can be about 16 msecs.

The arrangement described above may be necessary when a mobile unit 110 is operating within a systemless call environment 100 because the mobile unit 110 is not receiving signals from a network; the mobile unit 110 may constantly scan for incoming calls. In view of this increased vigilance, the idle stage 414 can help reduce the amount of current drain on the power supply 130.

Referring back to the method 300 of FIG. 3, at step 314, a call from an original transmitting unit can be received at a plurality of receiving mobile units. Also, at step 316, in the plurality of receiving mobile units, transmissions from the receiving mobile units can be selectively randomly delayed to reduce the probability that such transmissions will collide with one another. In one arrangement, this step can be performed if the incoming call is intended for the receiving mobile units. Here, there are at least two ways to carry out this selectively delaying step.

For example, at step 318, a pre-transmission scan can be performed when a transmission element of one of the receiving mobile units is activated. As an option, at step 320, an existing scan stage can be completed in lieu of performing the pre-transmission scan. At decision block 322, it can be determined—through the pre-transmission scan or the existing scan stage—whether another receiving mobile unit has begun to transmit. If no other receiving unit is transmitting, a transmission can be initiated in the receiving mobile unit whose transmission element has been activated, as shown at step 324.

If it is determined at decision block 322 that another receiving mobile unit is transmitting, then transmissions in the receiving mobile unit whose transmission element has been activated can be prevented, as shown at step 326. In addition, at step 328, the transmission from the other receiving mobile unit can be processed at the receiving mobile unit whose transmission has been prevented. This processing can occur if the transmission from the other receiving mobile unit is intended for the receiving mobile unit whose transmission has been prevented.

Referring to FIGS. 1 and 2, a user of the transmitting mobile unit 110A may wish to initiate a group call involving himself and the users of the receiving mobile units 110B and 110C. The user may activate the transmission element 112 of the transmitting mobile unit 110A, and in response, its transmitter 118 will cause a call to be transmitted. This incoming call can be received by the receivers 120 of the receiving mobile units 110B and 110C. Of course, a group call can include any suitable number of participants, and the invention is certainly not limited to this particular example.

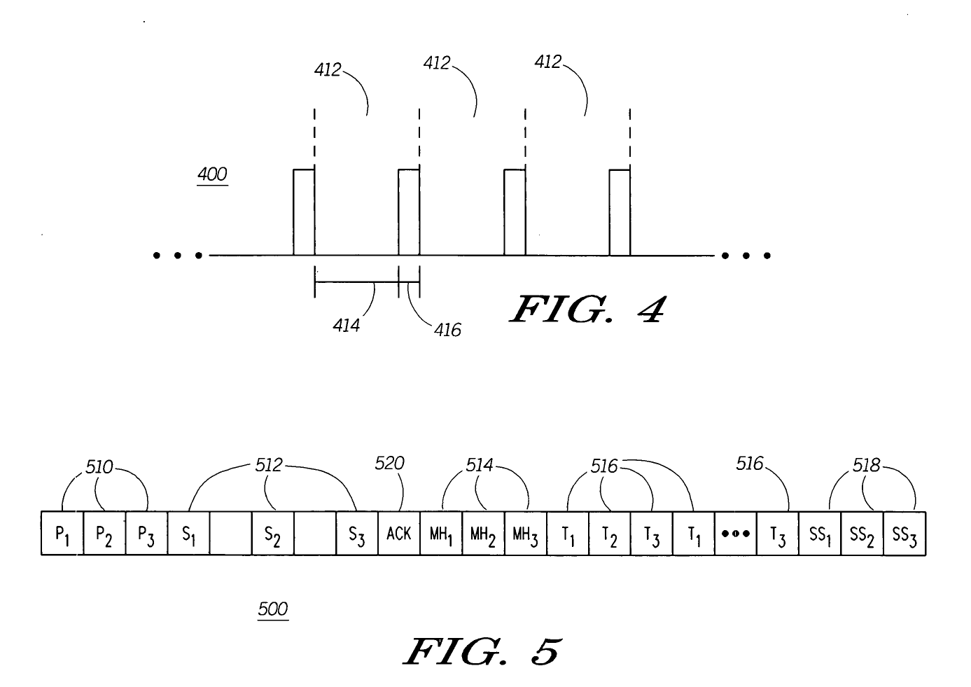

Referring also to FIG. 5, an example of a frame sequence 500 that represents frames exchanged between the transmitting mobile unit 110A and the receiving mobile units 110B and 110C (see FIG. 1) is shown. In one arrangement and as known in the art, the mobile units 110 can transmit to one another using a frequency hopping-spread spectrum (FHSS) protocol. As such, the transmitting mobile unit 110A can transmit frames in which the frames are transmitted at different frequencies. For example, the transmitting mobile unit 110A can transmit preamble frames 510 (P₁, P₂ and P₃) and synchronization frames 512 (S₁, S₂ and S₃) over different predefined frequencies. During the scan stage 416, the receivers 120 can scan the three different frequencies for the preamble frames 510 (of course, more or less than three frequencies can be scanned). This process can improve the chances that the receiving mobile units 110B and 110C will receive the frames being transmitted.

Referring to FIGS. 1, 2 and 5, the preamble frames 510 can wake up the receivers 120 of the receiving mobile units 110B and 110C and can assist in synchronizing the receiving mobile units 110B and 110C with the transmitting mobile unit 110A. The synchronization frames 512 can provide frame, bit and frequency-hopping synchronization as well as content information. As a more specific example, the synchronization frames 512 can include frequency hopping seeds. A frequency hopping seed can be an initial values used in the pseudo-random number generator 131 to generate new communication frequencies at which the mobile units 110A, 110B and 110C can communicate. Once the preamble frames 510 and synchronization frames 512 are processed by a receiving mobile unit 110, that receiving mobile unit 110 can be synchronized with a transmitting mobile unit 110.

After the receiver 120 of the receiving mobile units 110B and 110C processes the incoming preamble frames 510 and synchronization frames 512, the processor 114 can determine whether the incoming call is intended for the receiving mobile units 110B and 110C. If not, the incoming call can be ignored. If the call is intended for the receiving mobile units 110B and 110C, the remainder of the call can be received and processed at the receiving mobile units 110B and 110C.

The frame sequence 500 can also include message header frames 514 (MH₁, MH₂ and MH₃), traffic frames 516 (T₁, T₂ and T₃) and super stop frames 518 (SS₁, SS₂ and SS₃), all of which can be transmitted from the transmitting mobile unit 110A. The message header frames 514 can indicate message information, including the private identification of the transmitting mobile unit 110A. The traffic frames 516 can contain the actual voice or data being transmitted, and the super stop frames 518 can indicate the end of the transmission. The message header frames 514, the traffic frames 516 and the super stop frames 518 can all be transmitted at various frequencies, with the synchronization frames 512 providing information to the receivers 120 to permit the receivers 120 to tune to these frequencies.

The frame sequence 500 can also include an acknowledge (ACK) frame 520, which can be transmitted from the receiving mobile units 110B and 110C if the call is intended for them. The ACK frame 520 can be received by the transmitting mobile unit 110A, which can then begin transmitting the frames described above to the receiving mobile units 110B and 110C.

Once the initial transmission from the transmitting mobile unit 110A is complete, one or more users of the receiving mobile units 110B and 110C may wish to respond. These users may activate the transmission element 112 of the receiving mobile units 110B and 110C, such as pressing a PUTT button. In accordance with one embodiment of the inventive arrangements, the processor 114 of any of the receiving mobile units 110B and 110C whose transmission element 112 has been activated can instruct the receiver 120 to perform a pre-transmission scan.

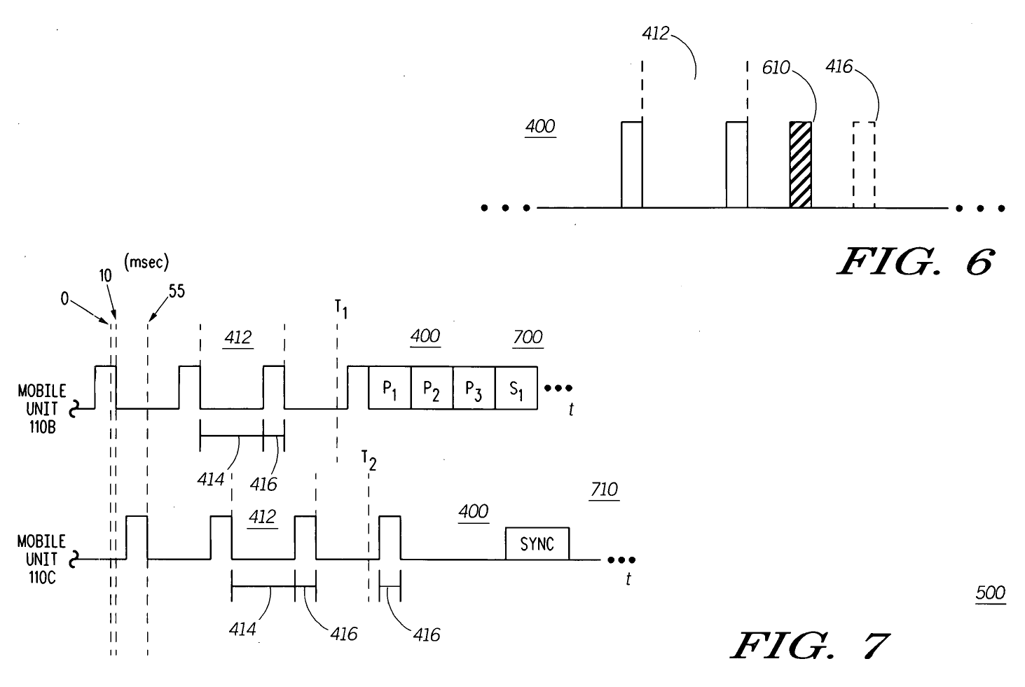

Referring to FIG. 6, an example of a pre-transmission scan 610 is shown. The pre-transmission scan 610 is shown with slanted lines to distinguish it from the scan stages 416. The idle mode 400 is shown with the pre-transmission scan 610 positioned within an idle stage 414. In one embodiment, the pre-transmission scan 610 can have a duration of roughly 16 msecs, although any other suitable temporal value is within contemplation of the inventive arrangements. The pre-transmission scan 610 may also cover one or more different frequencies, e.g., three different frequencies, like the scan stages 416. The pre-transmission scan 610, however, can be different from the scan stage 416 of an idle/scan period 412 (see FIG. 4) in that it may be dictated by the randomness of the activation of the transmission element 112 of a receiving mobile unit 110 (see FIG. 1). A scan stage 416 having a dashed outline is illustrated to show where the next scan stage 416 would have occurred if the transmission element 112 had not been activated.

During the pre-transmission scan 610, the receiver 120 of the receiving mobile units 110B and 110C (if their transmission elements 112 have been activated), can determine whether any other receiving mobile units 110 have begun transmitting. This receipt of signals from other receiving mobile units 110 can be in accordance with the discussion above relating to FIG. 5. If another receiving mobile unit 110 has already begun transmitting, the processor 114 can prevent the transmission in the receiving mobile units 110B and 110C whose transmission element 112 has been activated.

By performing the pre-transmission scan 610 when a transmission element 112 is activated, the receiving mobile units 110B and 110C can determine whether any other receiving mobile units 110 are transmitting within the idle stage 414. This process can reduce the probability of a transmission collision between the receiving mobile units 110B and 110C (or any other receiving mobile unit 110).

Of course, preventing the transmission in the receiving mobile units 110B and 110C may only be necessary if the incoming call is actually intended for them. Also, if the transmission has been prevented in either of the receiving mobile units 110B and 110C, then the transmission from the other receiving mobile unit 110 can be processed by the receiving mobile units 110B and 110C (assuming the call is intended for the receiving mobile units 110B and 110C).

In contrast, if the receiver 120 of the receiving mobile units 110B and 110C determine—through the pre-transmission scan 610—that no other receiving mobile units 110 are transmitting, the processor 114 can permit the transmitter 118 to proceed with the transmission. This transmission can be received at some other mobile unit 110 in accordance with the description above relating to FIG. 5. Of course, the pre-transmission scan applies to both the receiving mobile units 110B and 110C to limit the possibility that transmissions from either of them will interfere with the other. This pre-transmission scan process can be repeated for subsequent transmissions between the mobile units 110.

In one arrangement, an existing scan stage can be completed instead of performing a pre-transmission scan when a user of one of the receiving mobile units 110B or 110C activates a transmission element 112. For example, referring to FIGS. 1, 2 and 4, a user may activate the transmission element 112 of one of the receiving mobile units 110B and 110C when those mobile units 110B and 110C are within a scan stage 416. Rather than undergoing a pre-transmission scan 610 (see FIG. 6), the existing scan stage 416 may be completed to determine whether any other receiving mobile unit 110 is transmitting.

Referring back to the method 300 of FIG. 3, at step 330, a random delay can be assigned to an idle mode following a receive session in the receiving mobile units. At step 322, different seeds can be assigned for pseudo-random generators in the receiving mobile units to cause the random delay in the idle mode.

As explained earlier and referring to FIGS. 1, 2, 4 and 5, the receiving mobile units 110B and 110C can be synchronized with the transmitting mobile unit 110A. In certain systems, if a transmission element 112 of a receiving mobile unit 110 is activated in a particular idle/scan period 412, then the receiving mobile unit 110 may wait to complete that idle/scan period 412 before initiating the transmission. As such, because of the synchronization that has occurred, multiple receiving mobile units 110 may initiate transmissions at the same time if their transmission elements 112 are activated within the same idle/scan period 412.

In this example, once the receiving mobile units 110B and 110C process the super stop frames 518, the receiving mobile units 110B and 110C can assign a random delay to their idle modes 400. Assigning this random delay may also be referred to as a back-off process. Referring also to FIG. 7, a frame sequence 700 and an idle mode 400 for the receiving mobile unit 110B are shown. In addition, a frame sequence 710 and an idle mode 400 for the receiving mobile unit 110C are shown. Here, the receiving mobile units 110B and 110C have received a transmission from the transmitting mobile unit 110A and the super stop frames 518 (see FIG. 5) have been received.

In response, a random delay can be assigned to the idle modes 400 for both the frame sequences 700 and 710. In particular, a delay of 10 msecs has been assigned to the idle mode 400 of the frame sequence 700. Thus, an idle stage 414 can start at +10 msecs. Further, a delay of 55 msecs has been assigned to the idle mode 400 of the frame sequence 710, which corresponds to an idle stage 414 starting at +55 msecs. In one arrangement, the values for the random delays can be selected from 0 msecs to 80 msecs in 1 msec increments. Nonetheless, it is understood that the random delays can be any suitable value and are not limited to the examples listed above. The assigned random delays can desynchronize or stagger the transmissions from the receiving mobile units 110B and 11C, which can reduce the probability that transmissions from them will collide.

For example, at times T₁ and T₂, the transmission elements 112 for the receiving mobile unit 110B and the receiving mobile units 110C can be respectively activated. Because they are so close, in prior art systems, the times T₁ and T₂ will likely occur in the same idle/scan period 412. As a result, the transmissions would have occurred at the same time. But here, because of the random delay added to the idle/scan mode 400, the scan stage 416 for the receiving mobile unit 110C can detect the preamble frames 510 being transmitted from the receiving mobile unit 110B. In accordance with the discussion relating to FIG. 5, the receiving mobile unit 110C (and any other relevant mobile unit 110) can synchronize with and process the transmission from the receiving mobile unit 110B. This process of adding a random delay can be repeated for subsequent transmissions, if necessary.

To generate the delay for the idle/scan modes 400, different seeds can be assigned to pseudo-random number generators 131 in the receiving mobile units 110B and 110C. For example, the synchronization frames 512 can include a frequency-hopping seed, which can be assigned to the pseudo-random number generator 131 in the receiving mobile units 110B and 110C. As is known in the art, the pseudo-random number generators 131 of the receiving mobile units 110B and 110C can use the same seed to synchronize the transmission of signals between the receiving mobile units 110B and 110C and the transmitting mobile unit 110A.

In accordance with the inventive arrangements, once the receiver 120 receives the super stop frames 518, the processor 114 for the receiving mobile units 110B and 110C can assign different seeds to their respective pseudo-random number generators 131. Based on these seeds, the pseudo-random number generators 131 can assign the delay to the idle modes 400. Because the step of assigning the different seeds can be random in nature, the delay assigned to the idle modes 400 can be random, too. Because of the random delays, there is a greater chance that a scan stage 416 in the idle/scan mode 400 for one receiving mobile unit 110 can detect the transmission of another receiving mobile unit 110, as described above.

Referring back to the method 300 of FIG. 3, at step 334, the delaying of the transmission at the receiving mobile units can be repeated such that a delay is performed over a plurality of scans. The method 300 can then end at step 332.

Referring to FIGS. 1, 2, 4 and 5, as noted earlier, the frame sequence 500 includes frames that may be transmitted over different frequencies in view of the frequency hopping protocol employed by the mobile units 110. During a scan stage 416 or a pre-transmission scan 610, the receiving mobile units 110B and 110C can scan over these different frequencies in an effort to detect the preamble frames 510. One scan stage 416 or one pre-transmission scan 610, however, covers only one particular period in time. Thus, if for some reason, such as interference, one or more of the preamble frames 510 are not detected, the subsequent transmissions from the receiving mobile units 110B and 110C may collide.

To compensate for this possibility, multiple scans may be performed, which can repeat the delay of the transmission. For example, three pre-transmission scans 610 may be performed in succession, which can provide three different opportunities to detect the preamble frames 510. These pre-transmission scans 610 can be temporally spaced apart for any suitable duration, including being adjacent to one another. Moreover, if a preamble frame 510 is detected in an earlier pre-transmission scan 610, then it is not necessary to complete the remaining pre-transmission scans 610. It is understood that the invention is not limited to three pre-transmission scans 610 in this repeating process, as any other suitable number of pre-transmission scans 610 can be executed.

As another example, the randomly-delayed idle/scan periods 412 that are performed for the back-off process can be repeated to improve the chances that the preamble frames 510 will be detected. For example, a plurality of scan stages 416 (along with their associated idle stages 414) may be performed prior to enabling a transmission from the receiving mobile units 110B and 110C. The number of scan stages 416 that can be performed can be three, although other suitable values are within contemplation of the inventive arrangements. Similar to the description above, the repeating of the scan stages 416 can stop as soon as the receiver 120 detects one of the transmitted preamble frames 510. In either arrangement, the transmission of the receiving mobile units 110B or 110C may be selectively randomly delayed, as described above.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for reducing transmission collisions, comprising:
in a systemless call environment, receiving at a plurality of receiving mobile units a call from an original transmitting mobile unit; and
in the plurality of receiving mobile units, selectively randomly delaying transmissions from the receiving mobile units to reduce the probability that such transmissions will collide with one another.

2. The method according to claim 1, wherein selectively randomly delaying a transmission at the receiving mobile units comprises performing a pre-transmission scan when a transmission element of one of the receiving mobile units is activated.

3. The method according to claim 2, wherein if the pre-transmission scan determines that no other receiving mobile unit has begun to transmit, the method further comprises initiating transmission in the receiving mobile unit whose transmission element has been activated.

4. The method according to claim 2, wherein if the pre-transmission scan determines that another receiving mobile unit has begun to transmit, the method further comprises preventing transmission in the receiving mobile unit whose transmission element has been activated.

5. The method according to claim 4, wherein if the transmission from the other receiving mobile unit is intended for the receiving mobile unit whose transmission has been prevented, the method further comprises processing the transmission from the other receiving mobile unit at the receiving mobile unit whose transmission has been prevented.

6. The method according to claim 1, wherein selectively randomly delaying a transmission at the receiving mobile units comprises assigning a random delay to an idle mode following a receive session in the receiving mobile units.

7. The method according to claim 6, wherein assigning the random delay comprises assigning different seeds for pseudo-random number generators in the receiving mobile units to cause the random delay in the idle mode.

8. The method according to claim 1, wherein during an idle mode, the method further comprises performing an idle/scan period at the receiving units to determine the presence of an incoming call, wherein the idle/scan period includes an idle stage and a scan stage.

9. The method according to claim 8, further comprising completing an existing scan stage in lieu of performing a pre-transmission scan when a use, of one of the receiving mobile units activates a transmission element.

10. The method according to claim 1, further comprising repeating the delaying of the transmission at the receiving mobile units such that a delay is performed over a plurality of scans.

11. A mobile unit for reducing transmission collisions, comprising:
a transmitter;
a receiver; and
a processor coupled to the transmitter and the receiver, wherein the processor is programmed to:
detect the receipt of a call from an original transmitting mobile unit in a systemless call environment; and
selectively randomly delay a transmission from the mobile unit to reduce the possibility that such a transmission will collide with a transmission from another receiving unit.

12. The mobile unit according to claim 11, further comprising a transmission element coupled to the processor, wherein the processor is further programmed to selectively randomly delay the transmission at the mobile unit by performing a pre-transmission scan when the transmission element of the mobile unit is activated.

13. The mobile according to claim 12, wherein the processor is further programmed to determine, through the pre-transmission scan, whether any other receiving mobile unit has begun to transmit, and if not, the processor is further programmed to initiate the transmission in the mobile unit.

14. The mobile unit according to claim 12, wherein the processor is further programmed to determine, through the pre-transmission scan, whether any other receiving mobile unit has begun to transmit, and if so, the processor is further programmed to prevent the transmission in the mobile unit.

15. The mobile unit according to claim 11, wherein the processor is further programmed to selectively delay the transmission from the mobile unit by assigning a random delay to an idle mode following a receive session in the receiving mobile units.

16. The mobile unit according to claim 15, further comprising a pseudo-random number generator coupled to the processor, wherein the processor is further programmed to assign a seed for the pseudo-random number generator to cause the random delay in the idle mode.

17. The mobile unit according to claim 11, wherein during an idle mode, the processor is further programmed to perform an idle/scan period to determine the presence of an incoming call, wherein the idle/scan period includes an idle stage and a scan stage.

18. The mobile unit according to claim 17, further comprising a transmission element, wherein the processor is further programmed to complete an existing scan stage in lieu of performing a pre-transmission scan when the transmission element of the mobile unit is activated.

19. The mobile unit according to claim 11, wherein the processor is further programmed to repeat the delaying of the transmission of the mobile unit such that a delay is performed over a plurality of scans.

20. A machine readable storage having stored thereon a computer program having a plurality of code sections executable by a mobile unit for causing the mobile unit to:
in a systemless call environment, receive a call from an original transmitting mobile unit; and
in the plurality of receiving mobile communications units, selectively randomly delay a transmission from the mobile unit to reduce the probability that such a transmission will collide with another transmission.

21. The machine readable storage according to claim 20, wherein the code sections further cause the mobile unit to selectively randomly delay the transmission at the mobile unit by performing a pre-transmission scan when a transmission element of the mobile unit is activated.

22. The machine readable storage according to claim 20, wherein the code sections further cause the mobile unit to selectively randomly delay the transmission at the mobile unit by assigning a random delay to an idle mode following a receive session in the mobile unit.
